(19) United States
(12) Patent Application Publication
(10) Pub. No.: US 2006/0041377 A1
(43) Pub. Date: Feb. 23, 2006

(54) Method of estimating a position of a mobile object in a navigation system

(75) Inventors: Mun Ho Jung, Gyeonggi-do (KR); Dong Hoon Yi, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/202,858

(22) Filed: Aug. 11, 2005

(30) Foreign Application Priority Data
Aug. 17, 2004 (KR) 2004-0064538

(51) Int. Cl. G01C 21/36

(52) U.S. Cl. 701/209; 701/200

(57) ABSTRACT

A method of estimating a position of a mobile object in a navigation system is provided that comprises the steps of: loading a mobile object position data backed up during stoppage of the mobile object, at an initial stage of travel as the mobile object restarts traveling; estimating a current position of the mobile object from the loaded position data of the mobile object by dead reckoning navigation; causing the estimated current position of the mobile object to be matched to a map data; determining whether the mobile object has entered a link, based on the mobile object position matched to the map data and detection signals indicative of the travel conditions of the mobile object generated from a sensor part; and estimating the current position of the mobile object by establishing the azimuth angle of the link as an azimuth angle of the mobile object through the dead reckoning navigation if the mobile object is determined to have entered the link.

### CROSS REFERENCE TO RELATED APPLICATIONS

Pursuant to 35 U.S.C. § 119(a), this application claims the benefit of earlier fling date and right of priority to Korean Patent Application No. 10-2004-0064538, filed on Aug. 17, 2004, the content of which is hereby incorporated by reference herein in its entirety.

### FIELD OF THE INVENTION

The present invention is directed to a method of estimating a position of a mobile object in a navigation system that can assure an accurate estimation of a current position of a mobile object by establishing an azimuth angle of a link which the mobile object has entered, as an azimuth angle of the mobile object itself, when the current position of the mobile object has to be estimated by dead reckoning navigation due to failure of normal reception of navigation messages.

### BACKGROUND OF THE INVENTION

These days, traffic congestion becomes aggravated due to steady increase of mobile objects such as automotive vehicles and the like. This is particularly serious in that the expanding speed of social infrastructure including roads can hardly catch up with that of the number of mobile objects.

As one of the solutions to the traffic congestion, attention has been drawn to a navigation system where a Global Positioning System (GPS) receiver receives navigation messages periodically transmitted from earth-orbiting satellites for a global positioning system and sensors mounted on a mobile object detect the travel conditions, e.g., speed and heading. The navigation system is also adapted to determine a current position of the mobile object in response to the navigation messages received by the GPS receiver and the travel condition signals detected by the sensors, which in turn is matched to a map data and displayed on a display unit.

Such a navigation system enables a user of a mobile object to confirm a current position of the mobile object and the shortest route to a target destination from the current position. Under the guidance of the navigation system, the user can search in advance for a travel route along which the mobile object will run to reach the target destination and then drive the mobile object along the travel route thus searched, which makes it possible for the user to efficiently utilize a given road network.

At an initial stage of travel of the mobile object, which is an initial operation of the navigation system, there may occur such an instance that a navigation system fails to accurately receive the navigation messages transmitted from the GPS satellites for a period of 30 seconds minimum to 15 minutes maximum, depending on weather condition, building lay-outs around the mobile object, the solar spot and arrangement of the GPS satellites with respect to the current position of the mobile object. In the event that the navigation messages are not received accurately, the navigation system estimates the current position of the mobile object by what is called dead reckoning navigation. In other words, the navigation system can estimate a current position of the mobile object by taking advantage of the detection signals issued from a gyroscope, a vehicle speed sensor and the like, all of which are built in the mobile object.

In case of estimating the current position of the mobile object by the dead reckoning navigation, an azimuth angle of the mobile object is approximately detected by integrating the detection signals of the gyroscope and then accumulating the integrated values. Estimating the azimuth angle of the mobile object by the gyroscope detection signals in this manner, however, has a limitation in accurately detecting the azimuth angle of the mobile object, because a bit of error is generated each time of estimation and continues to accumulate as the mobile object travels.

In particular, due to the errors in the azimuth angle of the mobile object accumulated as the mobile object enters and continues to travel along a link of a map, there poses a drawback in that the current position of the mobile object cannot be precisely matched to the link but, instead, tends to be matched to the location that falls outside the link.

### SUMMARY OF THE INVENTION

Accordingly, it is an object of the present invention to provide a method of estimating a position of a mobile object in a navigation system adapted to minimize errors in an azimuth angle of the mobile object and thereby assure an accurate estimation of the current position of the mobile object by way of establishing the azimuth angle of a link which the mobile object has entered as the azimuth angle of the mobile object when the current position of the mobile object is estimated by dead reckoning navigation.

In accordance with one aspect of the instant invention, there is provided a method of estimating a position of a mobile object in a navigation system, comprising the steps of: loading a mobile object position data backed up during stoppage of the mobile object, at an initial stage of travel as the mobile object restarts traveling; estimating a current position of the mobile object from the loaded position data of the mobile object by dead reckoning navigation; causing the estimated current position of the mobile object to be matched to a map data; determining whether the mobile object has entered a link, based on the mobile object position matched to the map data and detection signals indicative of travel conditions of the mobile object generated from a sensor part; and estimating the current position of the mobile object by establishing the azimuth angle of the link as an azimuth angle of the mobile object through the dead reckoning navigation if the mobile object is determined to have entered the link.

In accordance with another aspect of the present invention, there is provided a method of estimating a position of a mobile object in a navigation system, comprising the steps of: detecting a mobile object position through the use of navigation messages received by a GPS receiver; calculating a dilution of precision value for the position detected; and comparing the dilution of precision value with a predetermined threshold value in a control part, wherein the current position of the mobile object is estimated by the dead reckoning navigation, if the dilution of precision value is equal to or greater than the threshold value.

In accordance with still another aspect of the present invention, there is provided a method of estimating a position of a mobile object in a navigation system, comprising the steps of; judging a position detected by the GPS receiver to be a current position of the mobile object if the dilution of precision value is less than the threshold value; and causing the judged position of the mobile object to match a map data.

Preferably, the determining step comprises the steps of: the mobile object having entered a relevant link if the position of the mobile object matches to the link of the map data and if it is confirmed from the detection signals of the sensor part that the mobile object has traveled forward for more than a predetermined distance; and detecting an azimuth angle of the mobile object in response to the detection signals of the sensor part and estimating the current position of the mobile object by the dead reckoning navigation if it is discriminated that the mobile object has not entered the link.

Preferably, the azimuth angle of the mobile object is detected by integrating the detection signals of a gyroscope in the sensor part and then accumulating the integrated values.

In accordance with still further aspect of the present invention, there is provided a method of estimating a position of a mobile object in a navigation system comprising the steps of: determining whether the mobile object stops traveling; and backing up a current position data of the mobile object if the mobile object is determined to have stopped.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a block diagram showing a navigation system to which a method of estimating a position of a mobile object according to the present invention is applied; and

FIGS. 2a and 2b are flowcharts illustrating a preferred embodiment of a method of estimating a position of a mobile object according to the present invention.

### DETAILED DESCRIPTION OF THE INVENTION

A preferred embodiment of a method of estimating a position of a mobile object in a navigation system according to the present invention will now be set forth in detail with reference to the drawings attached.

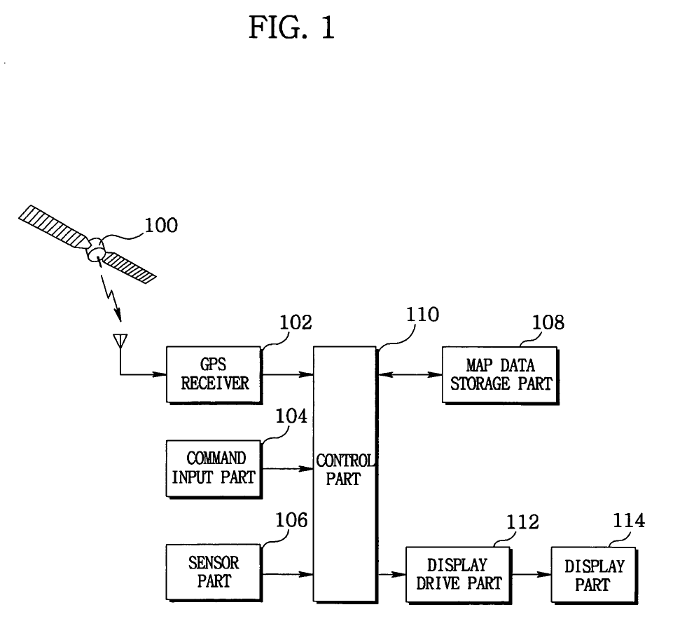

Referring to FIG. 1, there is shown a block diagram of a navigation system to which a method of estimating position of a mobile object according to the present invention is applied. In the Figure, reference numeral 100 designates a plurality of GPS satellites that orbit the earth and serve to periodically transmit navigation messages to a GPS receiver designated by reference numeral 102. The GPS receiver (102) extracts a current position of a mobile object by receiving at least four of the navigation messages transmitted from the plurality of GPS satellites (100). In addition, the GPS receiver (102) calculates a Dilution of Precision (hereinafter referred to as “DOP”) value on the basis of a position where it receives the navigation messages. Throughout this specification, it should be appreciated that the DOP value denotes a geometrical error stemming from a positional relationship of the GPS receiver with respect to those GPS satellites that transmit the navigation messages used in extracting the current position of the mobile object.

Reference numeral 104 designates a command input part through which a user can input operation commands to be executed, whereas reference numeral 106 designates a sensor part (106) which is a built-in device of the mobile object to detect travel conditions of the mobile object. The sensor part (106) includes, for instance, a gyroscope and a speed sensor mounted to the mobile object, both of which are used to detect the heading and a traveled distance of the mobile object.

Reference numeral 108 designates a map data storage part at which a map data is stored. Designated by reference numeral 110 is a control part. The control part (110) compares the DOP value calculated by the GPS receiver (102) with a predetermined threshold value. If the DOP value is less than the threshold value, the control part (102) judges the position extracted by the GPS receiver (102) to be a current position of the mobile object. On the other hand, in the event that the DOP value is equal to or greater than the threshold value, the control part (102) judges the current position of the mobile object in response to the detection signals from the sensor part (106). Moreover, the control part (110) serves to match the current position of the mobile object to the map data stored at the map data storage part (108) and to control the display thereof.

Reference numeral 112 denotes a display drive part. It plays a role in displaying the map and the current position of the mobile object on a display part (114) under the control of the control part (110).

In the navigation system thus described, the GPS receiver (102) receives at least four of the navigation messages transmitted from the GPS satellites (100), as the mobile object is caused to travel by a user. Based on the navigation messages received, the GPS receiver (102) detects the current position of the mobile object and calculates the DOP value, which in turn is sent to the control part (110).

The sensor part (106) detects travel conditions of the mobile object and then generates detection signals indicative of the travel conditions. In other words, the sensor part (106) produces pulse signals or other types of signals indicating azimuth angle variations and the travel distance of the mobile object.

The control part (110) compares the DOP value received from the GPS receiver (102) with a predetermined threshold value, wherein the DOP value remains small if the GPS satellites (100) are disposed uniformly with respect to the GPS receiver (102) but becomes greater if the disposition of the GPS satellites (100) is uneven. The DOP value is most preferably less than 2, preferably 2-3, and ordinarily 4-5. If the DOP value is equal to or greater than 6, it cannot be adopted because a great deal of errors would occur in the process of detecting the position of the mobile object based on the navigation messages received. For that very reason, the control part (110) stores a numeral 4 or 5 as a predetermined threshold value, compares the DOP value with the predetermined threshold value, and judges the position detected by the GPS receiver (102) to be the current position of the mobile object only when the DOP value is less than the predetermined threshold value.

If the DOP value is equal to or greater than the predetermined threshold value, the control part (110) estimates the current position of the mobile object based on the detection signals indicative of the travel conditions of the mobile object received from the sensor part (106), at which time the finally known position of the mobile object already determined when the DOP value remains less than the threshold value is used as a reference position. In this estimating process of the instant invention, the control part (110) determines whether the mobile object has entered the link and, if the mobile object is determined to be on the link, establishes an azimuth angle of the link which the mobile object has entered, as an azimuth angle of the mobile object, through a dead reckoning navigation, thereby reducing errors in the azimuth angle of the mobile object and assuring a precise estimation of the current position of the mobile object.

Once the current position of the mobile object is determined in this fashion, the control part (110) reads out the map data stored in the map data storage part (108) in order to match the current position of the mobile object to the map data, after which the matched map data is fed to the display drive part (112) so that the map and the current position of the mobile object can be displayed on the display part (114) in combination.

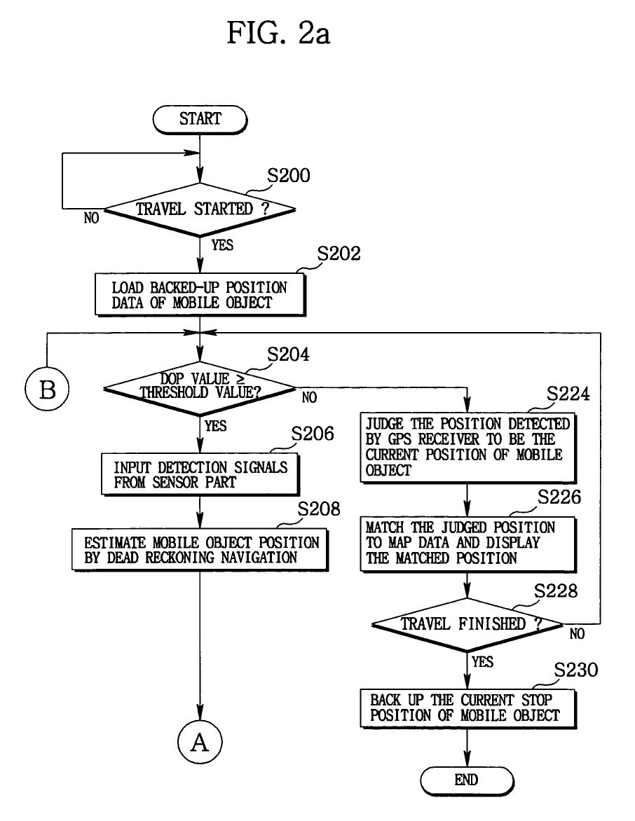

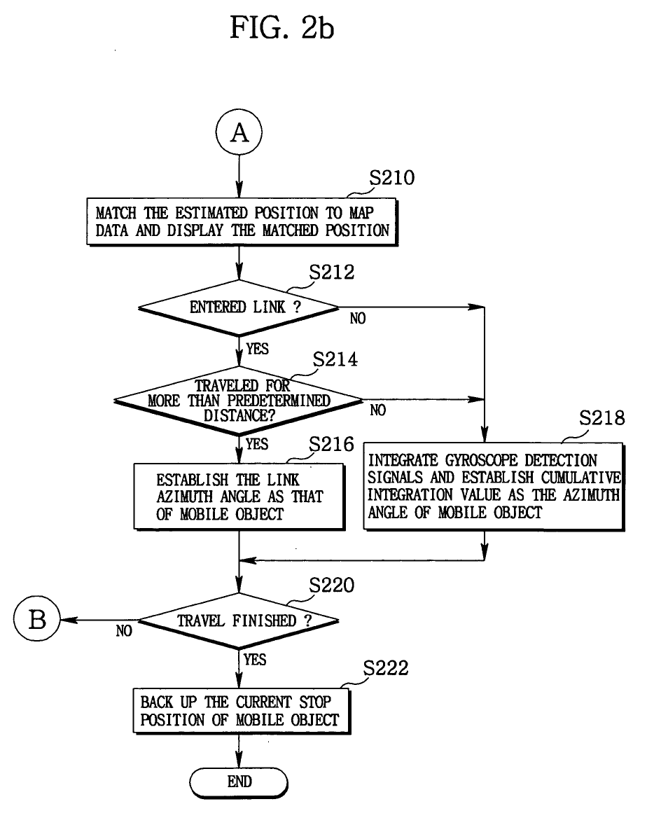

Turning now to FIGS. 2a and 2b, there are shown flowcharts illustrating the method of estimating a position of a mobile object according to the present invention. As illustrated in these figures, the control part (110) determines at the step of S200 whether the mobile object has begun to travel by use of the detection signals received from the sensor part (106). More specifically, in the event that the mobile object has begun to move, the gyroscope of the sensor part (106) generates azimuth angle detection signals indicative of the heading of the mobile object, while the speed sensor of the sensor part (106) issues pulse signals indicative of the speed of the mobile object. Responsive to the azimuth angle detection signals and the pulse signals sent from the sensor part (106), the control part (110) makes decision as to whether the mobile object has begun to travel.

If it is determined that the mobile object starts traveling, at the step of S202, the control part (110) loads, at the initial stage of travel, the mobile object position data backed up during stoppage of the mobile object as set forth infra and establishes the loaded position data as the current position of the mobile object.

At the step of S204, the control part (110) compares the DOP value received from the GPS receiver (102) with the predetermined threshold value. In a case that the DOP value is equal to or greater than the predetermined threshold value, it is impossible to accurately detect the current position of the mobile object in reliance upon the navigation messages that the GPS receiver (102) receives. On that account, at the step of S206, the control part (110) receives the detection signals indicative of the mobile object travel conditions from the sensor part (106) and, at the step of S208, estimates the current position of the mobile object by virtue of dead reckoning navigation. In other words, by taking the mobile object position data loaded at the preceding step as a reference position, the control part (110) estimates the current position of the mobile object through the use of the detection signals indicative of the mobile object travel conditions issued from the sensor part (106).

Once the current position of the mobile object is estimated in this manner, at the step of S210, the control part (110) matches the estimated current position of the mobile object to the map data stored in the map data storage part (108) and causes the matched current position of the mobile object to be displayed on the display part (114) through the display drive part (112), thus enabling the user to ascertain the current position of the mobile object.

At the step of S212, the control part (110) determines whether the current position of the mobile object is matched to the link of the map data and, at the step of S214, makes determination as to whether the mobile object has moved forward for more than a predetermined distance, by use of the detection signals indicative of the mobile object travel conditions fed from the sensor part (106), through which process the control part (110) decides an exact entry of the mobile object into the link. In the case of estimating the current position of the mobile object through the dead reckoning navigation in response to the detection signals from the sensor part (106), a great deal of errors may be generated in the azimuth angle of the mobile object which is detected by accumulating the detection signals of the gyroscope of the sensor part (106). As a result, there may take place such an event that the mobile object is erroneously matched to the link even though the mobile object lies out of the link. Taking this account, in accordance with the present invention, entry of the mobile object into the link is determined by discriminating whether, as a result of the current position of the mobile object being matched to the map data, the mobile object is matched to the link and whether the mobile object has traveled forward for more than, e.g., 100 m, in that link.

If it is discriminated that the current position of the mobile object is matched to the link and further that the mobile object has moved for more than the predetermined distance, the control part (110) then concludes that the mobile object has entered the link and, at the step of S216, establishes the azimuth angle of the link to which the current position of the mobile object is matched as the current azimuth angle of the mobile object.

To the contrary, if it is determined either that the current position of the mobile object is not matched to the link or that, even though the matching is successfully accomplished, the mobile object failed to move forward for more than a predetermined distance, the control part (110) concludes that the mobile object has not entered the link. At the step of S218, in the same manner as that of the prior art, the control part (110) integrates the detection signals received from the gyroscope of the sensor part (106) and establishes the cumulative value of integration as an azimuth angle of the mobile object.

The azimuth angle of the mobile object established in this manner is utilized in estimating the current position of the mobile object when the estimation is to be conducted by way of the dead reckoning navigation at the step of S208. Establishing the azimuth angle of the link which the mobile object has entered as the current azimuth angle of the mobile object as described above helps remove errors which would otherwise take place in the dead reckoning navigation, thus making sure that the current position of the mobile object can be estimated accurately and precisely.

At the step of S220, determination is made as to whether the mobile object finishes traveling and stops, viz, whether the engine of the mobile object is turned off. If it is determined that the mobile object has not stopped and continues to travel, flow returns to the step of S204 and the operation of comparing the DOP value with the predetermined threshold value is repeatedly performed.

In the event that the DOP value is determined to be less than the predetermined threshold value at the step of S204, the control part (110) concludes that the position detected by the GPS receiver (102) is trustworthy and, at the step of S224, judges the position detected by the GPS receiver (102) to be the current position of the mobile object. At the step of S226, the control part (110) matches the judged current position of the mobile object to the map data and causes the matched current position of the mobile object to be displayed on the display part (114) through the display drive part (112), thus enabling the user to ascertain the current position of the mobile object.

At the step of S228, determination is made as to whether the mobile object has finished traveling and stopped. If it is determined that the mobile object has not stopped and continues to travel, flow returns to the step of S204 and the operation of comparing the DOP value with the predetermined threshold value is repeatedly performed.

If the determination made at the steps of S220 and S228 reveals that the mobile object has ceased to travel with its engine turned off, the current stop position of the mobile object is stored as a backup data at the steps of S222 and S230, whose position data is used when the mobile object restarts traveling at a later time.

As apparent from the foregoing, the instant invention lies in that a position of a mobile object is estimated by way of dead reckoning navigation at an initial stage of travel under which the navigation messages are not received normally. If the estimated position is matched to a link and the mobile object is determined to have traveled forward for more than a predetermined distance, it is judged that the mobile object has entered the target road, an azimuth angle information thereof is established as an azimuth angle of the mobile object. This helps reduce the error in the azimuth angle of the mobile object which would otherwise occur in the dead reckoning navigation and assures that the current position of the mobile object can be estimated in a precise and accurate manner.

Although a preferred embodiment of the present invention has been described for the purpose of illustration, it should be understood that the invention is not limited to the particular embodiment disclosed herein. It will be apparent to those skilled in the art that various changes or modifications may be made thereto within the scope of the invention defined by the appended claims.

What is claimed is:

1. A method of estimating a position of a mobile object in a navigation system, comprising the steps of:
loading a mobile object position data backed up during stoppage of the mobile object, at an initial stage of travel as the mobile object restarts traveling;
estimating a current position of the mobile object from the loaded position data of the mobile object by dead reckoning navigation;
causing the estimated current position of the mobile object to be matched to a map data;
determining whether the mobile object has entered a link, based on the mobile object position matched to the map data and detection signals indicative of the travel conditions of the mobile object generated from a sensor part; and
estimating the current position of the mobile object by way of establishing the azimuth angle of the link as an azimuth angle of the mobile object through the dead reckoning navigation if the mobile object is determined to have entered the link.

2. The method as recited in claim 1, further comprising the steps of:
detecting the mobile object position through the use of navigation messages received by a global positioning system (GPS) receiver;
calculating a Dilution of Precision (DOP) value for the position detected; and
comparing the dilution of precision value with a predetermined threshold value in a control part;
wherein the current position of the mobile object is estimated by the dead reckoning navigation, if the DOP value is equal to or greater than the threshold value.

3. The method as recited in claim 2, further comprising the steps of:
judging the position detected by the global positioning system receiver to be the current position of the mobile object if the DOP value is less than the threshold value; and
causing the judged position of the mobile object to be matched to the map data.

4. The method as recited in claim 1, wherein, at the determining step, determination is made as to whether the mobile object has entered the link, if the position of the mobile object is matched to the link of the map data and if it is confirmed from the detection signals of the sensor part that the mobile object has traveled straight for more than a predetermined distance.

5. The method as recited in claim 1, wherein, if the mobile object is determined not to have entered the link, the current position of the mobile object is estimated by the dead reckoning navigation while detecting the azimuth angle of the mobile object from the detection signals of the sensor part.

6. The method as recited in claim 5, wherein the azimuth angle of the mobile object is detected by way of integrating detection signals of a gyroscope in the sensor part and then accumulating the integrated values.

7. The method as recited in claim 1, further comprising the steps of: determining whether the mobile object has stopped traveling; and backing up the current position data of the mobile object if the mobile object is determined to have stopped.

8. The method as recited in claim 7, wherein, at the stoppage determining step, determination os made as to whether the mobile object has stopped traveling, if an engine of the mobile object is turned off.
